(19) United States
(12) Patent Application Publication
(10) Pub. No.: US 2006/0185008 A1
(43) Pub. Date: Aug. 17, 2006

(54) Method, apparatus and computer program product enabling negotiation of firewall features by endpoints

(75) Inventors: Franck Le, Pittsburgh, PA (US); Yogesh Prem Swami, Irving, TX (US); Gabor Bajko, San Diego, CA (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/129,273

(22) Filed: May 12, 2005

Related U.S. Application Data
(60) Provisional application No. 60/652,137, filed on Feb. 11, 2005.

(51) Int. Cl. G06F 15/16

(52) U.S. Cl. 726/11

(57) ABSTRACT

Disclosed are examples of a method, system, devices and nodes to conduct communications between a device coupled to a communication network and a network security enforcement node, such as a firewall. An illustrative method includes, with a device coupled to a network security enforcement node through a communication network, requesting from the network security enforcement node information comprised of at least one of supported and enabled features and, in response to receiving the request, sending information descriptive of at least one of network security enforcement node supported and enabled features. The method may further include requesting by the device that at least one network security enforcement node feature be one of enabled or disabled.

### CLAIM OF PRIORITY FROM COPENDING PROVISIONAL PATENT APPLICATION

This patent application claims priority under 35 U.S.C. 119(e) from Provisional Patent Application No. 60/652,137, filed Feb. 11, 2005, the disclosure of which is incorporated by reference herein in its entirety.

### TECHNICAL FIELD

Various embodiments of this invention relate generally to communication network security procedures and, more specifically, relate to the security of Internet Protocol (IP) networks.

### BACKGROUND

While the number of threats is increasing in the Internet, firewalls play a crucial role in protecting end users and network resources. The 3GPP2 standards have recognized the importance of these network entities by deciding to specify their adoption and utilization in cdma2000 networks (see 3GPP2 Network Firewall Configuration and Control—Stage 1 requirements, November 2004). The IETF also acknowledged the value of these network entities and their needed presence in IP networks by defining several protocols such as MIDCOM (http://ietf.org/html.charters/midcom-charter.html), and NAT FW NSLP (http://www.ietf.org/internet-drafts/draft-ietf-nsis-nslp-natfw-04.txt) that allow firewall configuration.

Several security features have been developed and are implemented in current firewalls to prevent the occurrence of Denial of Service (DoS) attacks. While these features have provided some protection of the target machines, these features may present several issues when considering new applications and scenarios. The presence of these issues may result in data packets being dropped, or in the termination of the data communications. There are several features that are implemented in many current firewalls: 1) the Fragment Sanity Check, 2) the SYN Relay and 3) the TCP Sequence Verifier.

Fragment Sanity Check

As is explained in Check Point NG VPN-1/FireWall-1, Jim Nobe et al., Syngress Publishing Inc., 2003, some firewalls and IDS systems will not detect an attack if it is fragmented into smaller pieces. This happens because each packet is inspected individually as it passes through the device, and a fragment of the attacker's data will not be recognized as an attack. To avoid this problem a firewall collects all fragments and checks the reassembled packet before passing the information to the destination.

TCP Sequence Verifier

As is also explained by Nobe et al., every packet in a TCP session contains a sequence number in the TCP header information. The sequence number is important because it is the mechanism that is used to allow reliable communications between hosts. The sequence number identifies each assemblage of data so that the receiving host can reassemble the stream in the correct order, and can acknowledge each individual packet as it is received. If a sequence number is not acknowledged within a set period of time, the sender knows to retransmit the unacknowledged packet. In the case that a retransmission and the acknowledgment pass each other on the network, the receiving host will know to discard the duplicate packet because it has already seen the sequence number.

Most firewalls support a TCP sequence verifier that monitors all traffic flows going through a gateway, and that keeps track of the sequence numbers in the packets. If the firewall sees a packet that is received with an incorrect sequence number, the EP (Enforcement Point) considers the packet to be out-of-state and drops the packet. A network administrator may disable this feature since it is not supported in certain configurations, such as firewall clusters using asymmetric routing.

SYN Relay

The SYN Relay method has been designed to address the threat of Transport Control Protocol (TCP) SYN flooding (see http://www.cert.org/advisories/CA-1996-21.html for a for a description of the TCP SYN flooding type of malicious attack).

When used, the firewall will respond to all SYN packets on behalf of the server (protected by the firewall) by sending the SYN/ACK to the client. Once the ACK is received from the client, the firewall will pass the connection to the server. With this method, the server will never receive invalid connection attempts, because the firewall will not pass on the original SYN packet until it has received the corresponding ACK from the client. This method offers good protection for the target server, but also has significant overhead associated with its use as the firewall is required to respond to all connections requests passing through. Also, the firewall needs to be involved in the TCP connections. This is true because the TCP connection from the client actually ends at the firewall, and the firewall then establishes another TCP connection with the server.

Referring to FIG. 1, a malicious node 1 may be sending traffic via external networks 2, such as the Internet, through a firewall 3 to the cellular network 4. From the cellular network 4 the malicious traffic passes through the air interface 5 to the victim wireless terminal 6. The wireless terminal 6 is assumed to be associated with a cellular network subscriber. This can result in various problems in the cellular network 4, such as the problems related to overbilling, reduction of the victim's battery lifetime, and unnecessary consumption of the air interface bandwidth.

The above-noted Fragment Sanity Check and the TCP Sequence Verifier were designed to prevent malicious nodes from attempting to launch hidden attacks, or to attempt to inject bogus traffic (flooding). The SYN relay method is typically used when the EP detects that an active attack is on going (some threshold of attack attempts is exceeded) to protect target machines against a TCP SYN flood.

However when considering new applications and scenarios, these features that can typically be only enabled/disabled by the network administrator, may introduce a number of new and problematic issues.

For example, with multi-homing being standardized in the IETF, a node may have multiple interfaces and request its peer to send the traffic simultaneously over different routes (e.g. wireless local area network (WLAN) and general packet radio service (GPRS)) for reliability purposes. Depending on the quality of the different links, some packets may be received over link1 whereas other packets may be received from link2. The Fragment Sanity Check and the TCP Sequence Verifier, if enabled, may prevent packets from being delivered to the end point 1. The TCP Sequence verifier may further add additional delay by requesting that the sending node retransmit “missing” packets.

FIG. 2 shows a case of simultaneous TCP traffic over different paths that passes through two different and possibly unrelated firewalls (e.g., a WLAN firewall and a GPRS (cellular) firewall).

As was noted above, in the SYN Relay method the TCP connection is actually split into two different connections: one from the client 1 to the firewall 3, and one from the firewall 3 to the server 6, each one with its own Sequence Numbers. The client 1 and the server 6 do not have knowledge of the other peer's sequence number. If the client 1 and the server 6 want to use IPsec, the IPsec module at the end point 1 may drop the packets since the TCP sequence number may lead to differences in the IPsec checksum.

Firewall security features, even though designed to improve the security of the data communications, may result when used in certain scenarios in additional delay, or even in packets being dropped. In addition, the end points 1 (clients and servers) may not have knowledge as to the source of the problems since they often do not know what security features the firewall(s) 3 is implementing. Further, the endpoints do not have control over the operation of the firewall, since currently only the network administrator can enable/disable the security feature(s) used by the firewall 3.

While the end points 1 and 6 may have personal firewalls to protect the devices from different DoS attacks, and may implement multi-homing for additional reliability, or IPsec for enhanced security, the normal operation of the network firewall(s) 3 may prevent the data communication from occurring.

At present, the inventors are not aware of any currently used mechanism to allow an end point to know what features are being supported/implemented by the network firewall 3, and are also not aware of any currently used mechanism to allow the end point to enable/disable firewall features, such as the TCP Sequence Verifier, the Fragment Sanity Check and/or the SYN Relay features.

While the IETF is currently specifying protocols to configure firewalls, such as those described in “Middlebox Communications (midcom), M. Shore et al. http://ietf.org/html.charters/midcom-charter.html, and in “NAT/Firewall NSIS Signaling Layer Protocol (NSLP)”, M. Stiemerling et al., http://www.ietf.org/internet-drafts/draft-ietf-nsis-nslp-natfw-04.txt, the capabilities of these proposed protocols are basically limited to installing rules based on the source IP address, destination IP address, the Protocol, and the Port Numbers. While these protocols generally allow one to create pinholes, or install packet filters to block undesired traffic, they do not adequately address the problems discussed above.

### SUMMARY OF VARIOUS EMBODIMENTS

The foregoing and other problems are overcome, and other advantages are realized, in accordance with examples of embodiments of this invention.

One example of this invention provides a method to conduct communications between a device coupled to a communication network and a network security enforcement node, such as a firewall. The method includes, with a device coupled to a network security enforcement node through a communication network, requesting from the network security enforcement node information comprised of at least one of supported and enabled features and, in response to receiving the request, sending information descriptive of at least one of network security enforcement node supported and enabled features.

Another example of this invention provides apparatus that comprises a wireless network interface and a data processor for communication with a network security enforcement node, where the communication includes sending a request to the network security enforcement node to determine at least one of supported and enabled features.

Another example of this invention provides a computer program embodied on a computer-readable medium, where execution of the computer program directs a data processor of a wireless device for communication with a network security enforcement node, comprising an operation of sending a request to the network security enforcement node to determine at least one of supported and enabled features.

Another example of this invention provides apparatus that comprises a network interface and a data processor operable for communication with a device through the network interface, where the data processor is responsive to a first request from the device for information regarding network security enforcement capabilities of the apparatus to send the device information descriptive of at least one of network security enforcement supported and enabled features. The data processor may be further responsive to a second request from the device to selectively enable or disable at least one network security enforcement feature.

Another example of this invention provides a computer program embodied on a computer-readable medium, where execution of the computer program directs a data processor of a network security enforcement node to communicate with a device coupled to the network security enforcement node through a network interface. Operations performed include receiving a first request from the device for information regarding capabilities of said network security enforcement node; and sending the device information descriptive of at least one of network security enforcement node supported and enabled features. There may also be an operation, performed in response to receiving a second request from the device, to selectively enable or disable at least one network security enforcement node feature for device communications handled by the network security enforcement node.

A still further example of the invention provides apparatus that comprises a wireless network interface and a data processor operable to send, via the wireless network interface, a network security enforcement node a request for information descriptive of at least one of supported and enabled features, the data processor being further operable in response to receiving the information from the network security enforcement node to select a communication protocol.

### BRIEF DESCRIPTION OF THE DRAWINGS

The foregoing and other aspects of the presently preferred embodiments of this invention are made more evident in the following Detailed Description of the Preferred Embodiments, when read in conjunction with the attached Drawing Figures, wherein:

FIG. 1 depicts an example of malicious node sending malicious traffic to a wireless terminal via external networks, a firewall, a cellular network and the air interface of the cellular network, and is illustrative of the problem addressed by the preferred embodiments of this invention;

FIG. 2 shows an example of simultaneous TCP traffic over different paths that passes through two different and possibly unrelated firewalls;

FIG. 3 depicts an example of a logic flow diagram in accordance with an example of this invention;

FIG. 4 illustrates an example of a CDMA network that is one suitable environment in which to implement the teachings in accordance with this invention; and

FIGS. 5 and 6 are examples of logic flow diagrams that illustrate further examples of this invention.

### DETAILED DESCRIPTION OF THE PREFERRED EMBODIMENTS

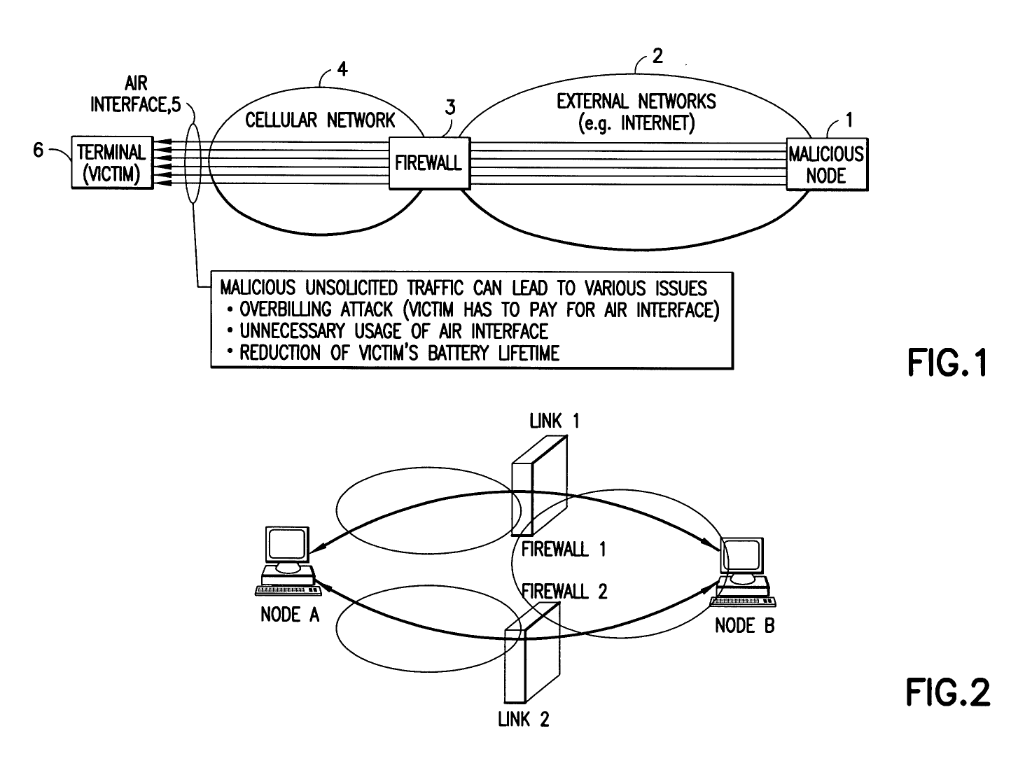

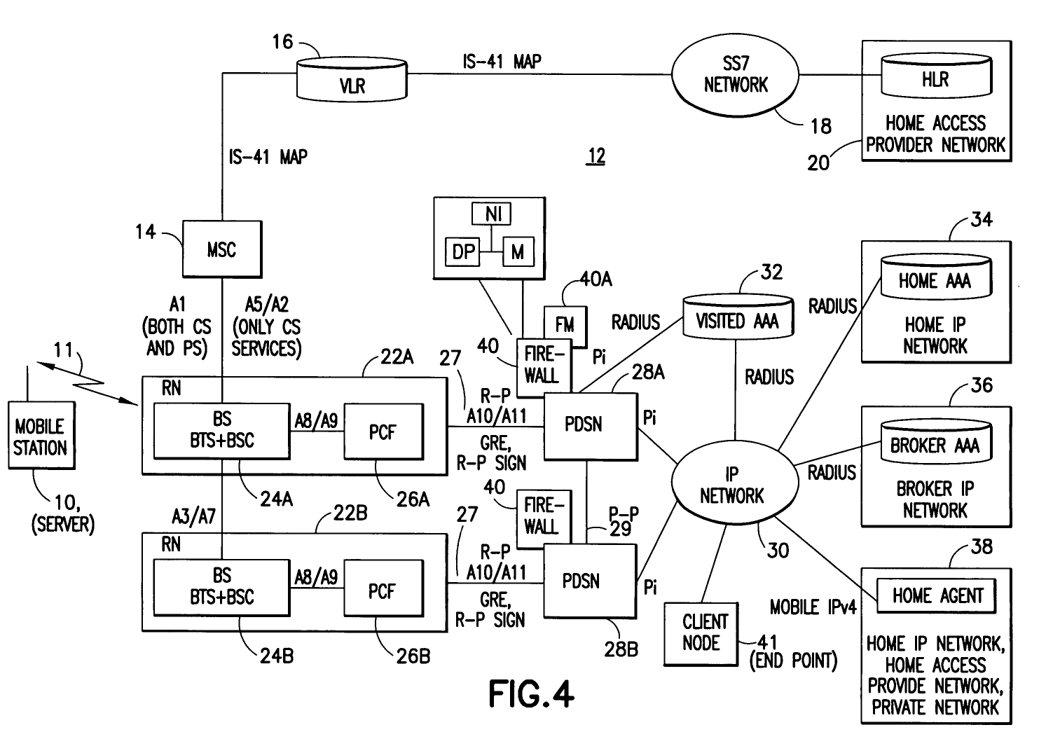

In the detailed description of some examples of this invention a network security enforcement node, such as a firewall, will be referred to as a firewall 40 (see FIG. 4), to distinguish it from the conventional firewall 3 discussed above in relation to FIG. 1. Further, the end point, also referred to herein as a device, or as a node, or as a client, will be designated as, e.g., end point 41 (see FIG. 4) to distinguish it from the conventional end point 1 that lacks the firewall 40 discovery and/or feature modification request capability in accordance with various examples of this invention.

Various examples of this invention relate to firewall 40 configuration protocols, and provide additional capabilities to be supported by firewall 40 configuration protocols in order to support future applications and scenarios.

Various examples of this invention provide techniques for an end point 41 to discover a firewall 40 and its capabilities, where an end point 41 is enabled to discover a network entity (either the firewall 40, or a manager 40A of the firewall 40, which may be co-located with the firewall 40) to which the end point 41 can send further requests concerning the features supported by the firewall 40. The techniques preferably allow the end point 41 to at least learn the features supported by the firewall 40 that can be enabled or disabled by the end point 41. Further, it is preferred that the techniques allow the end point 41 to learn the features supported by the firewall 40, even though the end point 41 cannot modify the feature(s). As an example, if the firewall 40 implements the Fragment Sanity Check, and the end point 41 is not authorized to disable this function, the end point 41 is still provided the opportunity to discover that Fragment Sanity Check verification is occurring, as it may be able to modify its own behavior based on this knowledge.

Various examples of this invention further provide techniques to negotiate and possibly modify the features implemented at the network firewall 40 (or firewalls), such that the end point 41 is enabled to enable/disable features at the network firewall(s) 40 that the network operator authorizes the end point 41 to modify.

The various examples of this invention may be used by the end point 41 to select a mechanism and/or protocol to be used for the end-to-end communication.

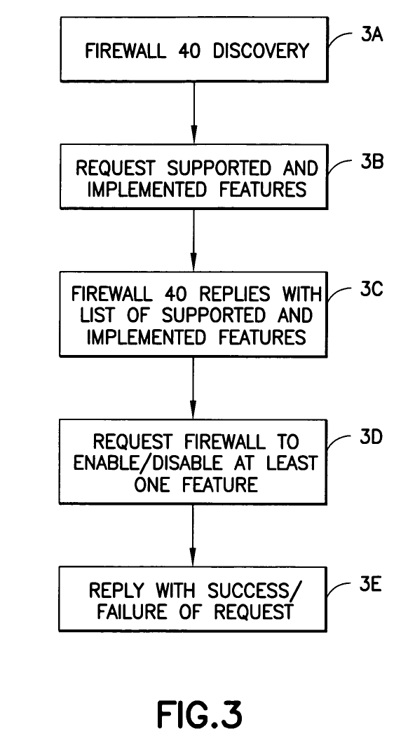

The following paragraphs describe a non-limiting technique to implement examples of this invention (e.g., how the firewall 40 capabilities are discovered), while the details of the underlying protocol strongly depend on the characteristics of the networks involved and the future evolution of the applicable standards. Reference is also made to the logic flow diagram of FIG. 3.

A first procedure (Block 3A) entails an optional firewall 40 discovery procedure, such as one conducted by the client node 41 shown in FIG. 4. As a few non-limiting examples, firewall 40 discovery can be performed using a Domain Name Server (DNS), or by using Dynamic Host Configuration Protocol (DHCP), or by sending an anycast message.

For example, the conventional purpose of DHCP is to enable individual computers on an IP network to extract their configurations from a server (the ‘DHCP server’) or servers, in particular, servers that have no exact information about the individual computers until they request the information. The overall purpose of this procedure is to reduce the work necessary to administer a large IP network. The most significant piece of information distributed in this manner is the IP address.

Still referring to FIG. 3, the end point 41 requests (Block 3B) from a firewall 40, such as a discovered firewall 40, the supported and enabled features. The firewall(s) 40 may then reply (Block 3C) by listing the supported and enabled features. The commonly used features, such as the Fragment Sanity Check, TCP Sequence Verifier, SYN Relay (as non-limiting examples), may be assigned a standardized value (e.g., 01, 02, 03, respectively), and firewall vendors may request a specific vendor value for some vendor-specific feature. Associated with each feature advertised by the firewall 40, a flag may inform the end point 41 whether the end point 41 can enable/disable the feature, or if the network firewall 40 implements the feature without the end point 41 having the ability to modify it. Another flag may inform the end point 41 of the default status of the feature, i.e., whether by default, the feature is enable or disabled. The end point 41 may then, if permitted, request that some certain feature or features be enabled or disabled (Block D). While single or multi-bit flags per se may be used, other techniques to impart this information may also be employed, such as simple text strings.

In a request to enable or disable a feature, the end point 41 may indicate what feature it is attempting to modify, such as by setting a flag to indicate whether it desires to enable or disable the targeted feature. Preferably, the end point 41 is enabled to configure one or more features per request. The network firewall 40 then preferably replies (Block 3E), informing the end point 41 if the end point 41 request has been successful or has failed.

It should be noted that the sequence from block 3B to block 3E may vary, and may include additional procedures, or modifications of the disclosed procedures. Note should also be taken that each of these procedures are substantially atomic operations, independent of one another.

In those networks where the firewall 40 configuration by an end point 41 is prohibited, the end point 41 may still benefit from having the capability to receive the firewall 40 implemented and enabled features. For example, in the case where the firewall 40 implements the SYN Relay feature, the end point 41 should preferably avoid using IPSec, as it will not be functional. Instead the end point 41 may use the Transport Layer Security (TLS) or some other upper layer security mechanism, that is operable with the SYN Relay feature. Thus, the end point 41 is enabled to modify its operation, such as by selecting a suitable protocol to ensure reliable end-to-end communication, based on the information discovered from a firewall 40.

Other firewall 40 features, not specifically discussed herein, may have similar security/transport/application layer implications as the SYN Relay feature. Knowledge of whether some specific feature is enabled or disabled in the firewall 40 thus may aid the end point 41 in selecting an appropriate protocol(s) for the end-to-end communications.

In accordance with examples of this invention, the protocol used with the firewall 40 for firewall 40 configuration purposes may also be used for:

1. fetching the features the firewall 40 supports; and/or

2. enabling/disabling those features in the firewall 40 (by the end point 41).

Note that the firewall 40 may support 10 features, while it may be desirable to enable only some subset of the 10 features (e.g., perhaps only five). This is useful in that the more features that the firewall 40 has enabled, the larger is the processing load on the firewall 40 and the lower its capacity to handle packet streams. Further, if some of the features are enabled they may prevent or impede some specific type(s) of communication. Therefore, the node may, as an example, disable a specific feature or features in the firewall 40 and begin that specific communication. When that communication ends, the node 41 may reconfigure the firewall 40 and re-enable the specific feature or features (see FIG. 5).

In FIG. 5, at Block 5A the end point 41 requests and receives those features supported by the fire wall 40. At Block 5B the end point 41 selectively disables at least one feature (e.g., disables the SYN Relay feature if using IPsec). At Block 5C the end point 41 is assumed to begin and conduct some specific communication that is assumed to pass through the firewall 40. At Block SD, at the conclusion of the communication, the end point 41 may re-enable the disabled feature(s) in the firewall 40 (e.g., may turn the SYN Relay feature back on).

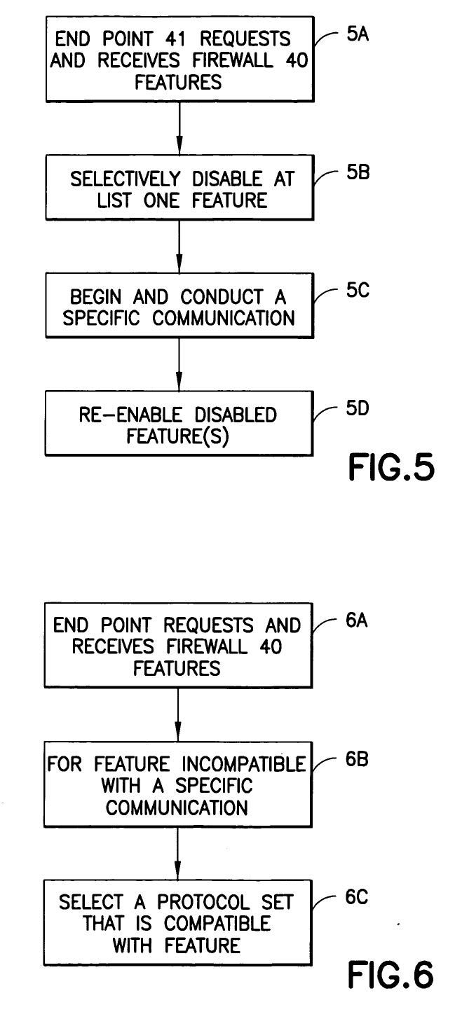

Note that the firewall 40 may not be configurable (at least by the end point node 41). In this case the node 41 may choose another way of communication. For example, and as was noted previously, the end point node 41 may elect to use another protocol set, such as a security protocol that operates or is compatible with the specific firewall 40 feature that cannot be disabled, but which may however be weaker than the feature which cannot be used (see FIG. 6).

In FIG. 6, at Block 6A the end point 41 request and receives the firewall 40 supported features. At Block 6B the end point 41 notes an enabled fire wall 40 feature that is not compatible with a specific communication. At Block 6C the end point 41 selects a protocol set that is compatible with the enabled firewall 40 feature in order to successfully conduct the communication.

The use of examples of this invention provides additional information as to how middle boxes (e.g., a firewall 40) process the data communications, and also provide a means for an end point 41 to configure how middle boxes should process the data communications.

The use of various examples of this invention provides additional flexibility, information and control to the end point 41. However, at the same time, the network operator may still determine what firewall 40 and other security features are preferred to be implemented in a given cellular network.

Further in this regard, reference may be had to FIG. 4 for showing a simplified block diagram of a wireless communication system, specifically a CDMA 2000 1× network, that is suitable for use in practicing the teachings of this invention. A description of FIG. 4 is provided in order to place the teachings of this invention into a suitable technological context. However, it should be appreciated that the specific network architecture and topology shown in FIG. 4 is not to be construed in a limiting sense upon the teachings of this invention, as the teachings of this invention may be practiced in networks having an architecture and topology that differs from that shown in FIG. 4. Further, the general concepts of the examples of this invention may be practiced as well in TDMA-based and other mobile TCP/IP networks, and are thus not limited for use only in a CDMA network. Both GSM and wideband CDMA (WCDMA) networks may benefit from the use of the various examples of this invention. While reading the ensuing description it should be noted that while some aspects of the description are specific to a CDMA network, the description of FIG. 4 is not intended to be read in a limiting sense upon the implementation, use and/or practice of the teachings in accordance with this invention.

The wireless communication system shown in FIG. 4 includes at least one mobile station (MS) 10. The MS 10 may be or may include a cellular telephone, or any type of mobile terminal (MT), or mobile node (MN), or more generally a device having a wireless communication interface and capabilities including, but not limited to, portable computers, personal data assistants (PDAs), Internet appliances, gaming devices, imaging devices and devices having a combination of these and/or other functionalities. The MS 10 is assumed to be compatible with the physical and higher layer signal formats and protocols used by a network 12, and to be capable of being coupled with the network 12 via a wireless link 11 that comprises the air interface. In the presently preferred examples of this invention the wireless link 11 is a radio frequency (RF) link, although in other examples of the use of this invention the wireless link 11 could be or include an optical link, and the MS 10 wireless network interface is compatible with one or both types of wireless link 11. The device that embodies the MS 10 may be considered to be a wireless device.

The MS 10 may or may not function as a server for a client node, which may be considered as the end point 41 discussed above (which could be another wireless device).

In a conventional sense the network 12 includes a mobile switching center (MSC) 14 coupled through an IS-41 Map interface to a visitor location register (VLR) 16. The VLR 16 in turn is coupled through an IS-41 Map interface to a switching system seven (SS-7) network 18 and thence to a home location register (HLR) 20 that is associated with a home access provider network of the MS 10. The MSC 14 is also coupled through an A1 interface (for circuit switched (CS) and packet switched (PS) traffic) and through an A5/A2 interface (CS services only) to a first radio network (RN) 22A. The first RN 22A includes a base station (BS) 24A that includes a base transceiver station (BTS) and a base station center (BSC) that is coupled through an A8/A9 interface to a Packet Control Function (PCF) 26A. The PCF 26A is coupled via an R-P (PDSN/PCF) interface 27 (also called an A10/A11 interface) to a first packet data serving node (PDSN) 28A and thence to an IP network 30 (via a Pi interface). The PDSN 28A is also shown coupled to a visited access, authorization and accounting (AAA) node 32 via a Pi and a remote authentication dial-in service (RADIUS) interface, that in turn is coupled to the IP network 30 via a RADIUS interface. Also shown coupled to the IP network 30 via RADIUS interfaces are a Home IP network AAA node 34 and a Broker IP network AAA node 36. A home IP network/home access provider network/private network Home Agent 38 is coupled to the IP network via a Mobile IPv4 interface. In accordance with RFC3220, the Home Agent 38 is a router on the home network of a mobile node (the MS 10 in this description) that tunnels datagrams for delivery to the mobile node when it is away from home, and that maintains current location information for the mobile node.

Also shown in FIG. 4 is a second RN 22B that is coupled to the first RN 22A via an A3/A7 interface. The second RN 22A includes a BS 24B and a PCF 26B and is coupled to a second PDSN 28B. The PDSN 28A and the PDSN 28B are coupled together through a P-P interface 29 (PDSN to PDSN interface, defined in IS835C).

The functionality of the firewall 40, in accordance with the examples of this invention (e.g., see FIG. 3) may be incorporated into the PDSN 28, or into another network node that is located before the wireless link (air interface) 11, such as the PCF 26, where the TCP packets of interest are present. In other types of wireless systems packet handling nodes of equivalent functionality can be used. As was noted, a firewall manager (FM) 40A function may also be present.

For the purposes of this invention the firewall 40 may be considered to be any network system or node interposed between the server (e.g., the MS 10) and the node (end point) 41 (which may be another MS), and may further be assumed to include at least one data processor (DP) that operates under control of a computer program that is stored on or in a computer-readable medium, such as a disk, a tape and/or a semiconductor memory (M), so as to implement the examples of this invention, and variations thereof, such as responding to a firewall 40 discovery request, selectively enabling or disabling a requested feature, and possibly reporting success or failure, as described above in reference to FIG. 3. A suitable network interface (NI) is also provided. At least one of the end point 41 nodes can be constructed in a similar manner and is also assumed to include at least one data processor (DP) that operates under control of a computer program that is stored on or in a computer-readable medium, such as a disk, a tape and/or a semiconductor memory (M), so as to implement the examples of this invention, such as initiating the firewall 40 discovery procedure, making a request to selectively enable or disable a firewall 40 feature or features, if allowed, and possibly selecting an appropriate communication protocol set for use with a discovered firewall 40 feature that cannot be disabled by the end point 41, as described above in reference to FIGS. 3, 5 and 6. The network interface (NI) for the end point 41 node may be a wired or a wireless interface.

Based on the foregoing description it should be apparent that a protocol has been disclosed. In the examples in accordance with this invention the protocol should allow the client to learn the features implemented in the firewall 40 and whether those features have been enabled or disabled. The protocol should allow the client to configure the firewall 40, such as by enabling or disabling a feature in the firewall 40. These capabilities are useful in a number of scenarios, such as providing advance knowledge of the features implemented in the firewall 40 so as to help nodes in choosing adequate protocols and succeed with end-to-end communications.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent messaging formats and protocols may be attempted by those skilled in the art. However, all such and similar modifications of the teachings of this invention will still fall within the scope of this invention. Furthermore, some of the features of the examples of this invention may be used to advantage without the corresponding use of other features. As such, the foregoing description should be considered as merely illustrative of the principles, teachings and various non-limiting examples and embodiments of this invention, and not in limitation thereof.

What is claimed is:

1. A method comprising
with a device capable of being coupled to a network security enforcement node through a communication network, requesting from the network security enforcement node information comprised of at least one of supported and enabled features; and
in response to receiving the request, sending information descriptive of at least one of network security enforcement node supported and enabled features.

2. A method as in claim 1, where sending comprises associating a flag with a feature to inform the device whether the device is allowed to enable/disable the feature.

3. A method as in claim 1, where sending comprises associating a flag with a feature to inform the device of a default state of the feature.

4. A method as in claim 1, further comprising requesting by the device that at least one network security enforcement node feature be one of enabled or disabled.

5. A method as in claim 4, further comprising informing the device if the request to enable or disable at least one firewall feature has been successful or has failed.

6. A method as in claim 1, where sending is performed by the network security enforcement node.

7. A method as in claim 1, where sending is performed by a manager of the network security enforcement node.

8. A method as in claim 1, further comprising an initial operation of initiating a network security enforcement node discovery procedure by the node, where requesting the information makes the request to a discovered network security enforcement node.

9. A method as in claim 1, further comprising selecting at least a communication protocol to be used by the device in response to receiving the information.

10. A method as in claim 1, further comprising:
requesting by the device that at least one network security enforcement node feature be disabled;
conducting a communication through the network security enforcement node; and
at the conclusion of the communication, requesting that the at least one network security enforcement node feature be re-enabled.

11. Apparatus comprising a wireless network interface and a data processor operable for communication with a network security enforcement node, said communication comprising sending a request to the network security enforcement node to determine at least one of supported and enabled features.

12. Apparatus as in claim 11, said communication further comprising sending a request to one of enable or disable at least one network security enforcement node feature.

13. Apparatus as in claim 11, said communication further comprising performing a network security enforcement node discovery procedure, said data processor initiating the communication with a discovered network security enforcement node.

14. Apparatus as in claim 11, said data processor operable to select at least one communication protocol in accordance with information received in response to the request.

15. Apparatus as in claim 11, said communication further comprising a request that at least one network security enforcement means feature be disabled, said data processor operable to thereafter conduct a communication through said network security enforcement node.

16. Apparatus as in claim 11, where at a conclusion of the communication, said communication further comprising a request that the at least one network security enforcement node feature be re-enabled.

17. A computer program embodied on a computer-readable medium, execution of said computer program directing a data processor of a wireless device for communication with a network security enforcement node, comprising an operation of sending a request to the network security enforcement node to determine at least one of supported and enabled features.

18. A computer program as in claim 17, execution of said computer program further comprising an operation of sending a request to one of enable or disable at least one network security enforcement node feature.

19. A computer program as in claim 17, execution of said computer program further comprising an operation of performing a network security enforcement node discovery procedure, and an operation of initiating the communication with a discovered network security enforcement node.

20. A computer program as in claim 17, execution of said computer program further comprising an operation of selecting a communication protocol in accordance with information received in response to the request.

21. A computer program as in claim 17, execution of said computer program further comprising an operation of requesting that at least one network security enforcement node feature be disabled, said data processor operable to thereafter conduct a communication through said network security enforcement node.

22. A computer program as in claim 21, execution of said computer program further comprising an operation of, at a conclusion of the communication, requesting that the at least one network security enforcement node feature be re-enabled.

23. Apparatus comprising a network interface and a data processor operable for communication with a device through the network interface, said data processor being responsive to a first request from the device for information regarding network security enforcement capabilities of said apparatus to send the device information descriptive of at least one of network security enforcement supported and enabled features.

24. Apparatus as in claim 23, said data processor being further responsive to a second request from the device to selectively enable or disable at least one network security enforcement feature.

25. A computer program embodied on a computer-readable medium, execution of said computer program directing a data processor of a network security enforcement node to communicate with a device coupled to the network security enforcement node through a network interface, comprising operations of: receiving a first request from the device for information regarding capabilities of said network security enforcement node; and sending the device information descriptive of at least one of network security enforcement node supported and enabled features.

26. A computer program as in claim 25, further comprising an operation, performed in response to receiving a second request from the device, to selectively enable or disable at least one network security enforcement node feature for device communications handled by said network security enforcement node.

27. Apparatus comprising means for interfacing to a wireless network and means for communication with a network security enforcement node, said communication means operable for sending a request to the network security enforcement node to determine at least one of supported and enabled features.

28. Apparatus as in claim 27, said communication means further operable for sending a request to one of enable or disable at least one network security enforcement node feature.

29. Apparatus as in claim 27, said communication means further operable for performing a network security enforcement node discovery procedure, and for initiating a communication with a discovered network security enforcement node.

30. Apparatus as in claim 27, further comprising means for selecting at least one communication protocol in accordance with information received in response to the request.

31. Apparatus comprising means for interfacing to a network and means for communication with a device via said network interface means and being responsive to a first request from the device for information regarding network security enforcement capabilities of said apparatus to send the device information descriptive of at least one of network security enforcement supported and enabled features.

32. Apparatus as in claim 31, said communication means further responsive to a second request from the device to selectively enable or disable at least one network security enforcement feature.

33. Apparatus comprising a wireless network interface and a data processor operable to send, via said wireless network interface, a network security enforcement node a request for information descriptive of at least one of supported and enabled features, said data processor being further operable in response to receiving the information from the network security enforcement node to select a communication protocol.

34. Apparatus as in claim 33, said data processor further operable to send the network security enforcement node a request to one of enable or disable at least one network security enforcement node feature.

35. Apparatus as in claim 33, said data processor further operable to initiate a network security enforcement node discovery procedure, and to send the request for information descriptive of at least one of supported and enabled features to a discovered network security enforcement node.
